(19) United States
(12) Patent Application Publication
(10) Pub. No.: US 2011/0303832 A1
(43) Pub. Date: Dec. 15, 2011

(54) Spatial Detection on an Electronic Device Using Optical Coding

(75) Inventors: Mats G. H. Wernersson, Helsingborg (SE); Gunnar Klinghult, Lund (SE)

(73) Assignee: Sony Ericsson Mobile Communications AB, Lund (SE)

(21) Appl. No.: 12/814,641

(22) Filed: Jun. 14, 2010

(51) Int. Cl. H01J 40/14

(52) U.S. Cl. 250/237 R

(57) ABSTRACT

A method of detecting motion at an electronics device includes a detector at the device. Light reflects from an object located external to the device and is projected onto a mask. The mask includes a predetermined pattern of light-transmissive and opaque areas that will either allow, or block the reflected light from passing through the mask and forming a light pattern on the light-sensitive surface of a light sensor. The light sensor generates a waveform based on this light-pattern, and a processor processes the generated waveform to detect whether the object is in motion.

### BACKGROUND

The present invention relates generally to electronic devices, and particularly to motion detection devices for electronic devices.

Electronic devices, such as cellular telephones for example, are very popular and often include ancillary components that allow a user to perform a variety of functions. For example, many communication devices typically come equipped with a camera that allows a user to capture images and/or video. Once captured, the user can usually send the image or video to a desired destination server, such as a network server, or to some remote party or device. Apart from such conventional uses, however, the cameras in these devices may be used to perform other functions like gesture detection or motion detection. Particularly, cameras in cellular telephones and other electronic devices can monitor the air volume in front of its lens and determine whether someone is moving relative to the device.

Although cameras are well-suited for capturing and sending images, there are drawbacks to their use as motion or gesture detectors. For example, cameras that detect motion include complex circuitry and components, and are usually more costly to manufacture. In addition, the cameras in some electronic devices must operate at high frame rates to detect motion, and generally consume large amounts of power.

### SUMMARY

The present invention provides a device and method for determining whether an object that is located externally to an electronics device is in motion with a low cost sensor. In one embodiment, the electronics device comprises a detector configured to detect motion external to the electronics device. The detector may comprise a light sensor configured to detect light on a light-sensitive surface, and to generate a waveform based on a detected light pattern, a mask having a predetermined pattern of light-transmissive and opaque areas to form the light pattern on the light-sensitive surface, and a processor configured to detect the external motion based on the generated waveform.

In one embodiment, the detector further comprises a lens to project the light through the mask and onto the light-sensitive surface.

In one embodiment, the device also includes a light source to emit the light detected by the light-sensitive surface.

In one embodiment, the predetermined pattern of light-transmissive and opaque areas comprises one or more openings formed in the mask that allows the light to pass through the mask to the light-sensitive surface. The one or more openings may be substantially vertically-oriented to distinguish horizontal motion, and/or substantially horizontally-oriented to distinguish vertical motion.

On one embodiment, the processor is configured to process the generated waveform to detect one or more transitions between light and dark, and determine a direction of movement based on a pattern of the detected transitions.

In some embodiments, the processor may further be configured to determine a size of an object in motion external to the electronics device based on the pattern of the detected one or more transitions.

In one embodiment, the detector comprises first and second detectors separated by a distance, each including a respective mask having the predetermined pattern of light-transmissive and opaque areas to form respective first and second light patterns on the light-sensitive surface.

In one embodiment, the light sensor may comprise first and second light sensors configured to generate corresponding first and second waveforms based on the first and second light patterns, respectively.

In one embodiment, the processor is configured to determine a distance between the electronics device and the object in motion based on a phase difference of the first and second waveforms.

In one embodiment, the mask comprises first and second masks, each mask has a different predetermined pattern of light-transmissive and opaque areas to form respective first and second light pattern on the light-sensitive surface. In such embodiments, the controller may be configured to multiplex the first and second light patterns to detect the external motion.

In at least one embodiment, the first and second masks are configured to be switched dynamically between the first mask and the second mask.

In another embodiment, the present invention provides a method of detecting motion at an electronics device. The method comprises projecting light onto a mask in an electronics device, masking the light through a predetermined pattern of light-transmissive and opaque areas to form a light pattern on a light-sensitive surface, generating a waveform based on the light-pattern, and processing the generated waveform at the electronics device to detect motion external to the electronics device.

In one embodiment, masking light through a predetermined pattern of light-transmissive and opaque areas comprises focusing the light to pass through a predetermined pattern of one or more openings formed in a mask.

In one embodiment, generating a waveform based on the light-pattern comprises generating a transition signal when the light-pattern indicates that an object external to the electronics device is moving.

In some embodiments, the method further requires generating the transition signal when the predetermined pattern of light-transmissive and opaque areas allow light reflected from the moving object to focus onto the light-sensitive surface.

In one embodiment, generating the transition signal when the predetermined pattern of light-transmissive and opaque areas blocks light reflected from the moving object from focusing onto the light-sensitive surface.

In one embodiment, processing the generated waveform at the electronics device comprises processing the generated waveform to detect one or more transitions between light and dark, identifying a pattern for the detected transitions, and determining a direction of movement based on the identified pattern of transitions.

In one embodiment, processing the generated waveform at the electronics device further comprises determining a size of the object in motion based on the detected pattern.

In one embodiment, the method further comprises masking the light through a pair of predetermined patterns of light-transmissive and opaque areas to form respective first and second light patterns on the light-sensitive surface, generating corresponding waveforms based on the first and second light-patterns, and processing the corresponding waveforms to determine a distance between the electronics device and an object in motion external to the electronics device.

In one embodiment, processing the corresponding waveforms to determine the distance between the electronics device and the object in motion comprises calculating the distance based on a phase difference between the first and second waveforms.

In one embodiment, masking the light through a predetermined pattern of light-transmissive and opaque areas comprises masking the light through first and second masks, each mask having a different predetermined pattern of light-transmissive and opaque areas to form respective first and second light patterns on the light-sensitive surface.

In one embodiment, the method further comprises multiplexing the first and second light patterns to detect the external motion.

In one embodiment, the method further comprises dynamically switching between the first mask and the second mask.

### BRIEF DESCRIPTION OF THE DRAWINGS

FIG. 1 is a block diagram illustrating some component parts of a wireless communication device configured according to one embodiment of the present invention.

FIG. 2 is an exploded view illustrating some of the components of a light detector configured to detect motion according to one embodiment of the present invention.

FIG. 3 illustrates a signal waveform generated by a light sensor responsive to detecting motion external to the wireless communication device in a first direction according to one embodiment of the present invention.

FIG. 4 illustrates a signal waveform generated by a light sensor responsive to detecting motion external to the wireless communication device in a second, opposite direction according to one embodiment of the present invention.

FIG. 5 illustrates a transition pattern generated based on the waveform illustrated in FIG. 3.

FIG. 6 is a flow diagram illustrating a method of detecting motion using a detector configured according to one embodiment of the present invention.

FIG. 7 is a perspective view of a mask suitable for detecting both horizontal and vertical motion according to one embodiment of the present invention.

FIG. 8 is a perspective view of a wireless communication device configured according to one embodiment of the present invention.

FIG. 9 is a flow diagram illustrating a method of detecting motion using the dual-detectors on the wireless communication device illustrated in FIG. 8.

FIGS. 10A-10B illustrate two different predetermined patterns for respective masks according to one embodiment of the present invention.

FIG. 11 illustrates another way to determine movement using the masks seen in FIG. 10.

### DETAILED DESCRIPTION

The present invention provides a device and method for detecting the motion of an object, such as a user's hand, for example, in a 3-Dimensional (3D) space proximate an electronics device. Rather than utilize a camera to detect the motion, which requires costly and complex circuitry, the present invention utilizes a single cost-effective light detector mounted on the electronics device. As used herein, the term “light” is defined to include electromagnetic radiation of any wavelength, regardless of whether it is visible or invisible to the human eye. Such “light” includes, but is not limited to, ultraviolet (UV) light, visible light, and infra-red (IR) light. In one preferred embodiment, the wavelength λ of the “light” is between about 0.1 μm and about 1000 μm.

In one embodiment, the light detector includes a lens that focuses light reflecting off an object in motion onto a mask. A predetermined pattern of light-transmissive and opaque areas are formed in the mask. The light-transmissive areas allow the light to pass through the mask to a light-sensitive surface, while the opaque areas block the light from passing through to the light-sensitive surface. The light that passes through the mask forms a corresponding light pattern on the light-sensitive surface that changes as the object moves through a 3-D space in front of the device. The light-sensor generates a waveform based on the changing light-pattern and sends it to a processor. The processor processes the waveform and analyzes the results to detect the motion.

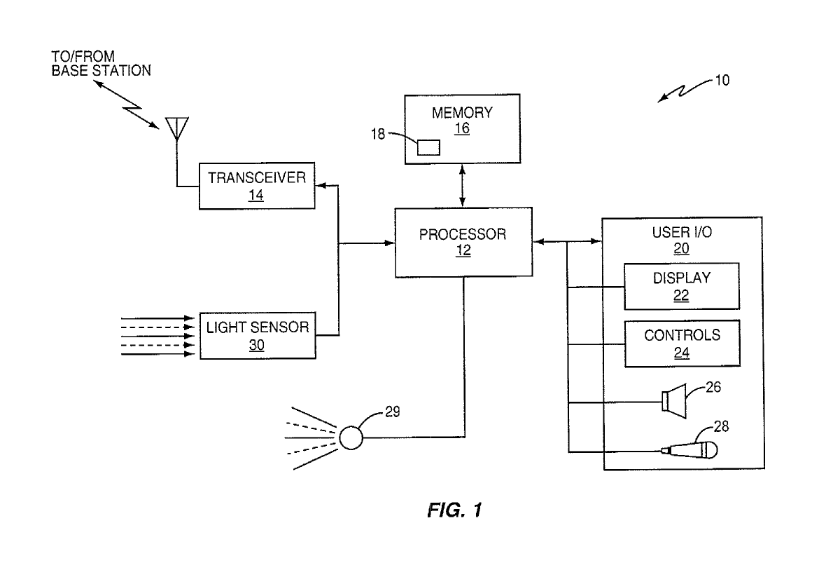

Turning now to the drawings, FIG. 1 is a block diagram illustrating an electronics device 10 configured to function according to one embodiment of the present invention. As seen in the figures and as described in the specification, device 10 comprises a SMARTPHONE-type cellular telephone. However, this is for illustrative purposes only. Those skilled in the art will readily appreciate that the present invention is not limited solely to use in SMARTPHONES, but instead, may be used in any of a wide array of electronic devices where there is a need to detect motion. Examples of some other types of suitable electronics devices include, but are not limited to, computing devices (e.g., personal, desktop, laptop, notebook, tablet, etc.), conventional camera-equipped cellular telephones, personal digital assistants (PDAs), and satellite phones.

Device 10 comprises a programmable processor 12, a communications interface 14, which in this case is a wireless transceiver, a memory 16, a user input/output interface 20, a detector 30, and, in some embodiments, a device that emits light, such as a Light Emitting Diode (LED) 29. Processor 12 generally controls the overall operation of device 10 according to programs and instructions stored in memory 16. The processor 12, which may be implemented in hardware, firmware, software, or a combination thereof, may comprise a single microprocessor or multiple microprocessors. The microprocessors may be general purpose microprocessors, digital signal processors, or other special purpose processors. As described in more detail later, the processor 12 is programmed to analyze one or more waveforms generated by the light detector 20 to determine whether an object, such as the user's hand, is moving in the 3-D space in front of device 10.

The communication interface 14 allows the device 10 to communicate messages and other data with one or more remote parties and/or devices. In this embodiment, the communication interface 14 comprises a fully functional cellular radio transceiver that can operate according to any known standard, including the standards known generally as the Global System for Mobile Communications (GSM), the General Packet Radio Service (GPRS), cdma2000, Universal Mobile Telecommunications System (UMTS), Wideband Code Division Multiple Access (WCDMA), 3GPP Long Term Evolution (LTE), and Worldwide Interoperability for Microwave Access (WiMAX). In other embodiments, however, the communication interface 14 may comprise a hardware port, such as an Ethernet port, for example, that connects device 10 to a packet data communications network. In yet another embodiment, the communication interface 14 may comprise a wireless LAN (802.11x) interface.

Memory 16 comprises a computer-readable medium that may include both random access memory (RAM) and read-only memory (ROM). Although not specifically shown in the figures, those skilled in the art will appreciate that the memory 16 may also be embodied as other tangible components, such as compact disks (CDs), hard drives, tapes, and digital video disks (DVDs) that may be integrated with or connected to the device 10 via an interface port (not shown). Computer program instructions and data required for operation of device 10 are stored in non-volatile memory, such as EPROM, EEPROM, and/or flash memory, which may be implemented as discrete devices, stacked devices, or integrated with the processor 12.

One such computer program is application module 18. The application module 18 contains computer program instructions that, when executed by processor 12, controls the processor 12 to analyze waveforms generated by detector 30. Based on this analysis, the processor 12 may determine whether an object in front of device 10 is in motion, and if so, which direction the object is moving. In some cases, as is described in more detail later, the application module 18 may contain instructions and data that allow the processor 12 to determine the size of the object in motion as well as the distance between the object and device 10.

The User Interface (UI) 20 includes components that allow a user to interact with device 10. These components include, but are not limited to, a display 22 one or more global controls 24 to enable the user to interact with and control the device 10, a speaker 26 to render audible sound to the user, and a microphone 28 to detect audible sound from the user. Additionally, in some embodiments, device 10 may include a light source 29 to emit light. As described in more detail below, the light source 22 may be controlled by the processor 12 to illuminate an area in front device 10. The light source 29 may emit any type of light regardless of whether it is visible or invisible to the human eye. This includes, but is not limited to, visible light as well as UV and IR light. However, the type of light emitted will depend on the type of light that detector 30 is configured to sense.

The detector 30 functions to detect light and to provide the processor 12 with one or more generated waveforms that indicate the movement of an object proximate the device 10. Particularly, light enters the detector 30, but the amount of light that enters is affected by the object as it moves in front of device 10. Based on these changes in light, the detector 30 generates waveform signals and sends them to the processor 12 for processing. The processor 12 then processes and analyzes the waveform to determine whether the object is moving, as well as the direction in which it is moving.

The detector 30 may be any detector known in the art and may detect light that is either visible to the human eye, or invisible to the human eye. The detector 30 may also be either “active” or “passive.” An active detector is a sensor that utilizes a light source to emit its own light, while a “passive” detector utilizes only ambient light. In one embodiment of the present invention, for example, detector 30 is an “active” detector comprising a light-sensitive photodiode that utilizes light emitted by light source 29. The photodiode may be sensitive to light in the visible spectrum, in which case light source 29 would emit visible light to illuminate the object, or it may be sensitive to Infra Red (IR) light that a human eye cannot detect, in which case light source 29 would emit IR light to illuminate the object. In either case, before emitting the light, the light source 22 could be configured to modulate the light at a predetermined frequency, such as a frequency within the range of 30-300 kHz. Upon receiving the modulated light, detector 30, or other circuitry within device 10, could filter out received light having a frequency outside this range. This would leave only the modulated light emitted by light source 29 to be processed by processor 12. Such filtering will generally suppress disturbances and other interference that originate from other light sources, such as lamps or the sun.

In contrast to an active detector, a “passive” detector does not utilize its own light source to illuminate an object of interest. Instead, passive detectors rely on ambient light or radiation, such as natural light, lamp light, and black body radiation, to illuminate the object. For example, in embodiments where detector 30 detects visible light, detector 30 can comprise a photodiode that senses movement of an object using only the ambient light. In embodiments where detector 30 detects IR light, however, detector 30 may comprise a pyroelectric IR sensor. These types of sensors are configured to detect and measure black body radiation or long wave IR radiation (e.g., body heat). Generally, the wavelength of such radiation is about 5 μm and is not visible to the human eye.

Pyroelectric IR sensors are especially advantageous for use with the present invention because they require very little current to operate, thereby minimizing the draw on energy resources provided by a battery. For example, pyroelectric IR sensors typically consume about 2 μA. Post amplification of the signals generated by such a sensor would also require about 2 μA. Because the power consumption is so minimal, a pyroelectric IR sensor could continuously remain in an “on” state to monitor external movements. This differs from other types of sensors, such as the “active” type sensors, for example, that require more current to operate, and thus, should be disabled when not in use to conserve battery power. However, pyroelectric IR sensors are effective enough only to detect the movements of a human hand.

As with the active sensors, a passive detector 30, or other circuitry in device 10, may be configured to filter out extraneous light or radiation at unwanted frequencies. Thus, the device 10 may be configured to ensure that other external heat and/or light sources, such as the sun or a lamp, do not interfere with the ability of the detector 30 to measure the light reflected by, or the heat radiated by, the moving object.

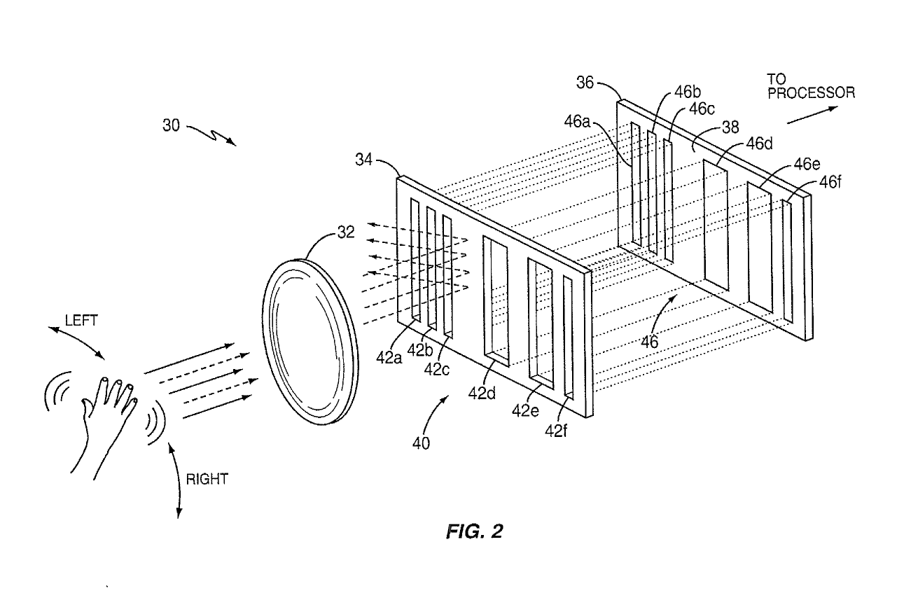

FIG. 2 is an exploded view of a detector 30 configured to detect motion according to one embodiment of the present invention. For illustrative purposes only, the following description discusses detector 30 in terms of being a passive photodiode capable of detecting visible light reflected by a human hand that is moving back and forth in front of device 10. However, those skilled in the art will appreciate that the detector 30 of FIG. 2 may be “active” in that it will utilize light source 29 if the ambient light in insufficient. Further, as previously stated, detector 30 may alternately be configured to detect other types of radiated energy, regardless of whether it is visible or invisible to the human eye.

Detector 30 comprises a lens 32, a mask 34, and a light sensor 36 having a light-sensitive surface 38. In operation, light reflected from a user's hand moving in front of the detector 30 is reflected into the device 10 through the lens 32 and onto the light-sensitive surface 38. However, not all light will strike the light-sensitive surface. Particularly, mask 34 comprises a predetermined pattern 40 of light-transmissive areas 42a-42f (collectively referred to here in as light-transmissive areas 42) and light-opaque areas 44 that either allow the reflected light to reach, or block the reflected light from reaching, the light sensor 36, respectively. The light that strikes the light sensor 36 forms a light pattern 46 on the light-sensitive surface 38 that corresponds to the predetermined pattern 40. As seen later in more detail, the light sensor 36 will generate signal waveforms based on the changes in the amount of light that strikes the light-sensitive surface 38.

The predetermined pattern 40 may be any pattern needed or desired to detect a desired motion and may, for example, be created by the manufacturer when assembling device 10. For example, in one embodiment, the predetermined pattern 40 is created using an etching process. In other embodiments, the predetermined pattern 40 is formed using a laser cutting process, or from a transparent filament, for example. In this embodiment, the light-transmissive areas 42a-42f comprise a plurality of sequential, vertically-oriented, elongated openings of the same or different widths that allow light to pass through the mask 34. The light-opaque areas 44, however, comprise the areas disposed between and/or around the openings that block the light from passing through the mask 34. Like the light-transmissive areas 42a-42f, the light opaque areas 44 may have different widths, thereby spacing the light-transmissive areas 42a-42f at different distances from each other. However, this is not required, and the light-opaque areas 44 may be the same widths, thereby spacing the light-transmissive areas 42a-42f at substantially equidistant intervals across the mask 34.

The light that passes through each of the light-transmissive areas 42a-42f in mask 34 strikes the light-sensitive surface 38 of sensor 36. This forms a light pattern 46 on the light-sensitive surface 38 consisting of areas 46a-46f. The number and spacing of these areas 46a-46f substantially conforms to the number and spacing of the light-transmissive areas 42a-42f in the predetermined pattern 40 on mask 34. As the user moves a hand in front of the detector 30, the amount of light that passes through each of the light-transmissive areas 42a-42f changes in sequence. Thus, the amount of light that reaches the light-sensitive area 38 also changes in sequence. Based on this sequence of changes, the light sensor 36 generates signal waveforms for processing by the processor 12. Because the sequence of light-transmissive areas 42a-42f in the predetermined pattern 40 is unique, the resultant waveform that is generated when the hand moves from right to left in front of the detector 30 is different from the waveform that is generated when the hand moves in the opposite direction from left to right. This allows the processor 12 to identify direction of movement.

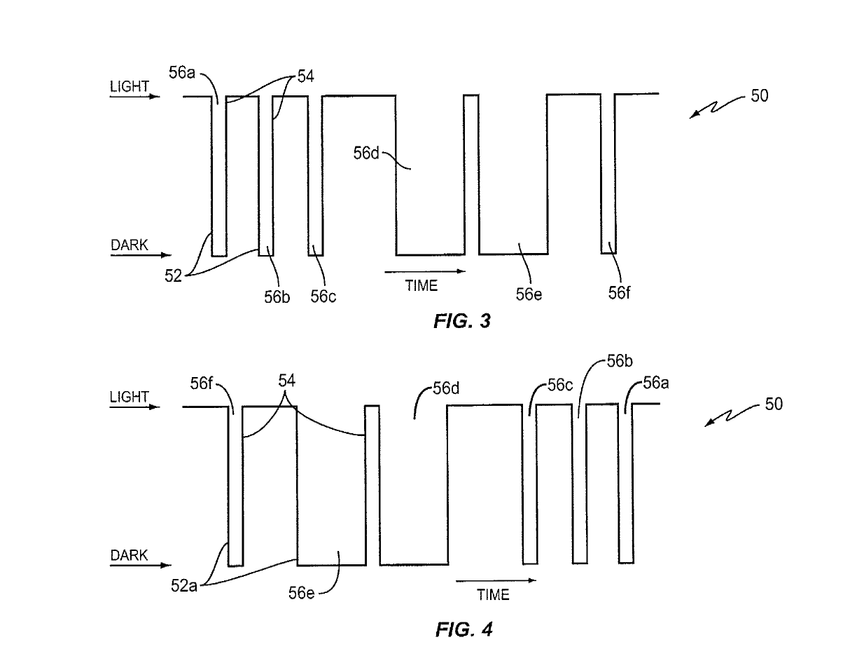

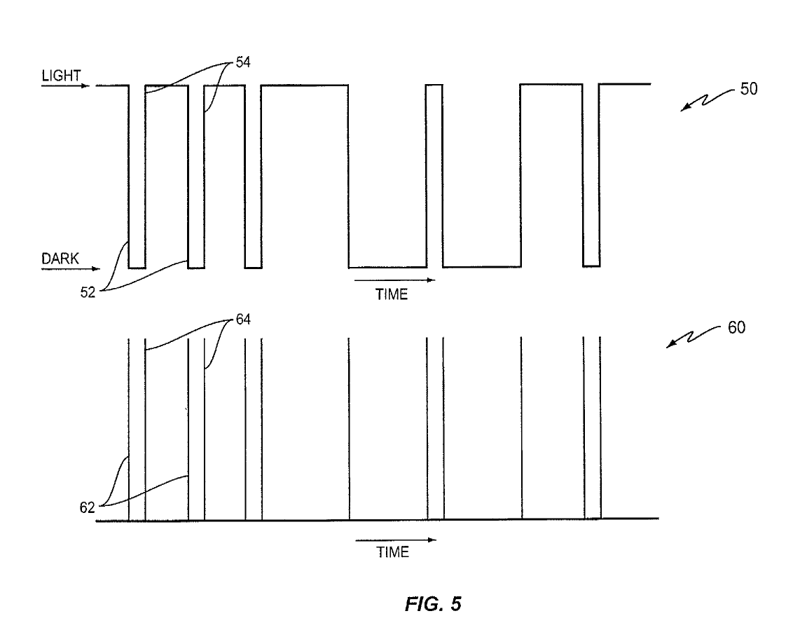

FIGS. 3 and 4, for example, illustrate waveforms 50 generated by the light sensor 36 as the user moves the hand from left-to-right (FIG. 3) and in the opposite direction from right to left (FIG. 4). When the light sensor 36 detects light in an area 46a-46f that would usually receive light in the light pattern 46, the light sensor 36 generates a high signal. When the light sensor 36 detects that there is less light striking the areas 46a-46f (i.e., those areas are darker), the light sensor 36 generates a low signal. Thus, as the user's hand moves in front of detector 30 from right to left, it alternately allows/blocks at least some light from passing through the light-transmissive areas 42a-42f in sequence. As the user's hand moves in the opposite direction from left to right, it alternately allows/blocks at least some light from passing through the light-transmissive areas 42f-42a in the reverse sequence. The light sensor 36 detects this sequence of changes in the amount of light striking the light-sensitive surface 38 and transitions between generating a high signal and a low signal. That is, each time the light sensor detects a change from light to dark (or dark to light) in an area 46a-46f, the signal transitions 52a from high to low. Similarly, upon detecting a change from dark to light (or light to dark) in an area 46a-46f, the signal transitions 52b from low to high. This sequence of changes in the light pattern 46 indicates that the user's hand is moving in front of the detector 30, as well as the direction of movement.

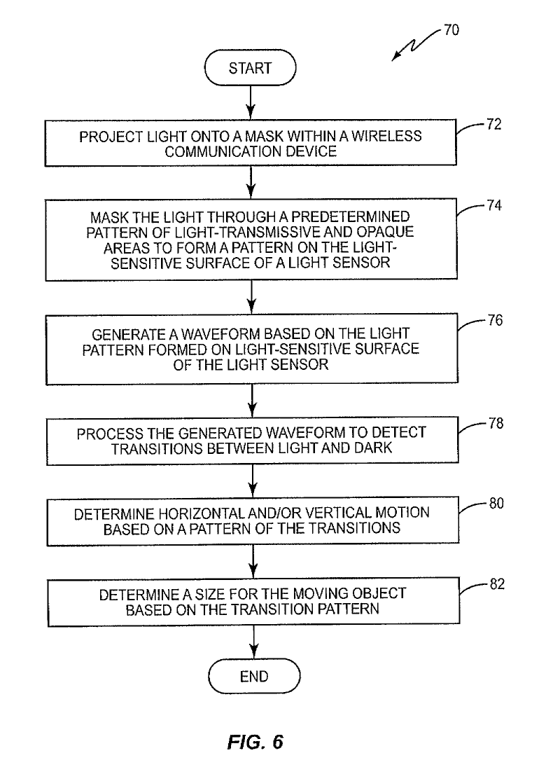

FIG. 5 illustrates the analysis performed by processor 12 according to one embodiment of the present invention in more detail. Particularly, the waveform 50 generated by light sensor 36 in this figure indicates that the user is moving his or her hand from left-to-right. Upon receipt, the processor 12 processes the waveform 50 to remove the high and low “spikes” from the signal. This may be accomplished, for example, by filtering the signal to remove the “spikes” as is known in the art. The processing then leaves processor 12 with a resultant transition pattern 60 that indicates the sequence of signal transitions from high to low 62a and from low to high 62b. This sequential pattern is unique, and thus, can be compared by processor 12 against other transition pattern sequences stored in memory 16. As a match is found, the processor 12 can determine that the user's hand is moving, as well as the direction in which it is moving.

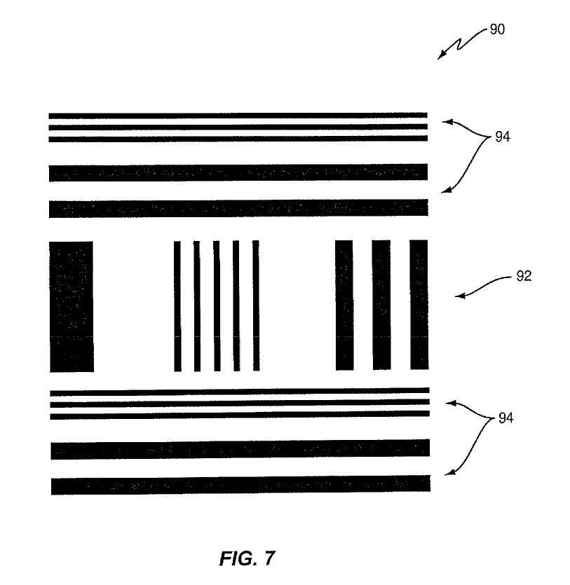

FIG. 6 is a flow diagram illustrating a method 70 by which detector 30 senses movement according to one embodiment of the present invention. Method 70 begins with light reflecting off the user's hand, through the lens 32, and onto mask 34 within the wireless communication device (box 72). The reflected light passes through each light-transmissive area 42a-42f in the mask 34 such that the predetermined pattern of light-transmissive areas 42 and light-opaque areas 44 form a corresponding light pattern 46 on the light-sensitive surface 38 of light sensor 36 (box 74). Based on the light pattern 46 formed on the light-sensitive surface 38, which changes as the user's hand moves, the light sensor 36 generates a corresponding waveform 50 (box 76). The processor 12 then processes the generated waveform 50 to remove the “spikes,” and analyzes the resultant transition pattern 60 to detect the unique pattern of transitions between light and dark and dark to light (box 78). The processor 12 compares the transition pattern 60 to one or more known transition patterns stored in local memory 16 and, based on the outcome of the comparison, determines whether the user's hand is moving and in what direction it is moving (box 80).

In some embodiments, the processor 12 may also determine a size of the object moving in front of detector 30 (box 82). For example, the processor 12 may determine the size of the user's hand based on the number of light-transmissive areas 42 that simultaneously allow light to pass through to the light-sensitive surface 38. For example, larger hands will prevent a larger portion of light from striking the light-sensitive surface 38 relative to a smaller hand. Thus, based on the number of areas 46a-46f that receive less light, the processor 12 can determine the size of the user's hand. However, it should be understood determining the size of an object in front of device 10 requires that the object be within a specified distance of the detector 30.

Depending on the orientation of the light-transmissive areas 42 and the light-opaque areas 44 of the predetermined pattern 40, the processor 12 can determine whether movement is vertical or horizontal. For example, the vertically-oriented areas 42 of the previous embodiments allow the processor 12 to determine horizontal movement. However, arranging the light-transmissive areas 42 to be horizontally-oriented would allow the processor 12 to detect vertical movement. Alternatively, however, the present invention could be configured to detect movement in multiple directions.

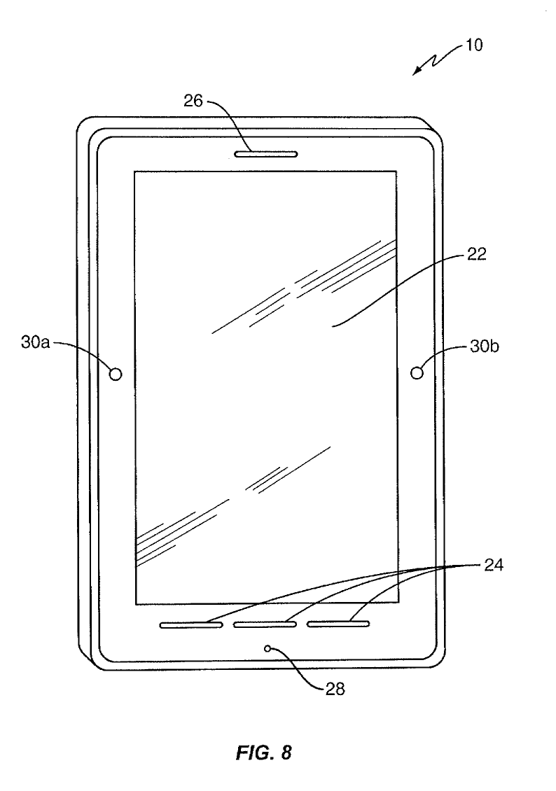

FIG. 7, for example, illustrates a mask 90 formed with both vertically-oriented and horizontally-oriented light-transmissive areas 92, as well as opaque areas 94 disposed between and around the light-transmissive areas 92. With such masks 90, the generated waveforms 50 would reflect changes in light that occur when the user's hand is moving horizontally and/or vertically. Thus, the processor 12 could the process the waveforms 50 and compare the specific transition pattern 60 that is generated against a set of known patterns to determine left-to-right, right-to-left, up-and-down, and diagonal movement.

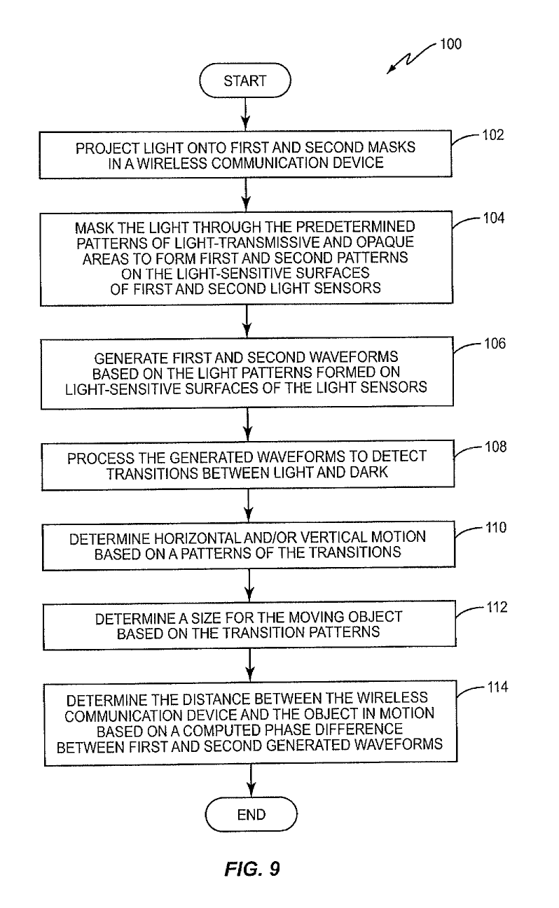

FIG. 8 is a perspective view illustrating another embodiment that utilizes a pair of laterally-spaced detectors 30a, 30b. As seen in FIG. 8, device 10 comprises a cellular telephone having a User I/O Interface 20 that includes speaker 26, touch-sensitive display 22, global control buttons 24, and microphone 28. Although not specifically shown here, those of ordinary skill in the art will readily appreciate that device 10 may include other user interface controls.

The detectors 30a, 30b in this embodiment are disposed on either side of the display 22. Each detector 30a, 30b is structured to include the same components as previously described in FIG. 2. Further, each detector 30a, 30b functions in the same manner as that previously described. An advantage to utilizing a pair of detectors 30 rather than only a single detector 30 is that dual detectors 30a, 30b will allow the processor 12 to determine a distance between the device 10 and a hand in motion in addition to determining the direction of movement and the size.

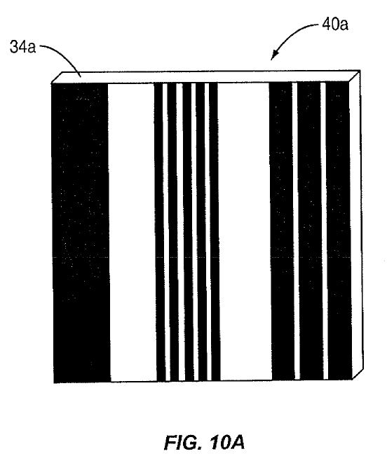

FIG. 9 is a flow diagram illustrating a method 100 by which the dual detectors 30a, 30b sense movement according to another embodiment of the present invention. Method 100 begins with light reflecting off the user's hand, through the lenses 32 of both detectors 30a, 30b, and onto the respective masks 34 within the wireless communication device 10 (box 102). The reflected light passes through each mask 34 separately such that the predetermined patterns of light-transmissive areas 42 and light-opaque areas 44 form corresponding light patterns 46 on the light-sensitive surfaces 38 of each light sensor 36 (box 104). Based on the light patterns 46 formed on the light-sensitive surfaces 38, which change as the user's hand moves, each light sensor 36 of each detector 30a, 30b generates a corresponding waveform 50 (box 106). The processor 12 receives the generated waveforms 50 and processes the waveforms 50 to remove the “spikes” in the generated waveform signals, and to detect the unique pattern of transitions between light and dark and dark to light (box 108). The processor 12 then compares one or both of the transition patterns 60 to one or more known transition patterns stored in local memory 16 and, based on the outcome of the comparison, determines whether the user's hand is moving and in what direction it is moving (box 110), and if desired, the size of the user's hand as previously described (box 112).

Additionally, the processor 12 can also be configured to process the generated waveforms 50 to determine a distance between the device 10 and the user's hand. In one embodiment, for example, the processor 12 is configured to compute a phase difference between the independent waveforms 50 generated by respective detectors 30a, 30b. Any method known in the art may be used to compute the phase difference. Based on this computed phase difference, the processor can determine the distance between the user's hand and the device 10.

The present invention may, of course, be carried out in other ways than those specifically set forth herein without departing from the essential characteristics of the invention. For example, the previous embodiments describe the ability of detector 30 to generate waveforms by detecting the changes in reflected light as they go from light to dark. However, the present invention is not so limited. The detector 30 may be configured to detect changes in light from dark to light. Additionally, the present invention is not limited to the use of a specially prepared mask 34 having a predetermined pattern 40, but rather, may utilize a component of the device 10 as the mask 34, and dynamically change the pattern 40 as needed.

For example, in one embodiment of the present invention, the display 22 is a Liquid Crystal Display (LCD) that functions as the mask 34. LCD displays, as is known in the art, typically comprise a layer of liquid crystal molecules aligned between two transparent electrodes and two polarizing filters. The liquid crystal molecules can be controlled to rotate about an axis between first and second orientations. In the first orientation, the liquid crystal molecules are aligned so as to allow light to shine through the liquid crystals. In the second orientation, the liquid crystal molecules are aligned so as to block light from shining through the liquid crystals. The orientation of the liquid crystal molecules can be controlled by applying an electric field to selected electrodes. Particularly, the electric field causes those liquid crystal molecules that contact the electrodes to rotate on an axis from the first orientation to the second orientation (or vice versa).

In this embodiment, the processor 12 could be controlled to apply an electric field to selected electrodes to rotate the liquid crystal molecules in selected portions of the display 22 to the second orientation to block light while allowing the molecules in the other portions of the display 22 to remain oriented in the first orientation. Those molecules aligned in the first orientation would correspond to the light-transmissive areas 42 of pattern 40, while those molecules aligned in the second orientation would correspond to the light-opaque areas 44 of the pattern 40. As previously described, light shining through the display 22 onto a light-sensitive surface is detected by the processor 12 and analyzed to determine movement and the direction of movement.

The pixels could also be controlled to rotate between the first and second orientations dynamically to generate different patterns 40 based on any of a variety of factors. Some exemplary factors include, but are not limited to, an amount of ambient light that is available for detecting movement, a desired resolution, and a velocity of an object, a distance of a moving object.

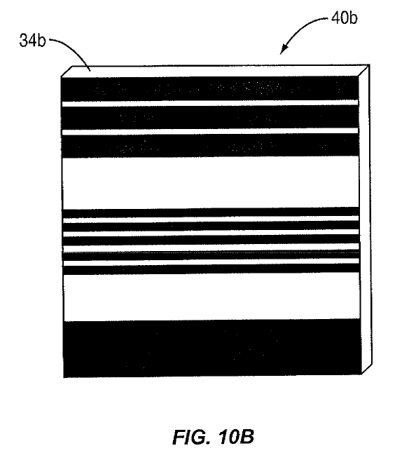

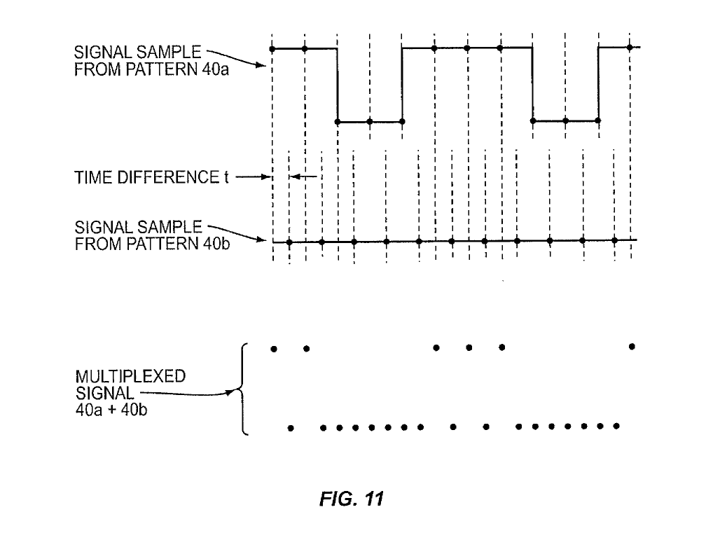

In addition, the mask 34 could be comprised of two or more different masks 34, each having a different pre-determined pattern 40. For example, FIGS. 10A-10B show two different masks 34a, 34b, each having its own pre-determined pattern 40a, 40b, respectively. Pattern 40a for mask 34a is configured to detect horizontal motion, and thus, it does not detect vertical motion. However, pattern 40b for mask 34b is configured to detect vertical motion, but does not detect horizontal motion. A user could alternately display masks 34a, 34b manually utilizing a mechanical means or autonomously by using an electronic circuit. The resultant signals, seen in FIG. 11, would represent motion in both the vertical and horizontal directions. From these “sampling points,” and a known difference in time t, the electronic device 10 could multiplex the signals, and use those signals to determine movement and the direction of movement. Diagonal movement could be identified using signals output by both patterns 40a, 40b.

Therefore, the present embodiments are to be considered in all respects as illustrative and not restrictive, and all changes coming within the meaning and equivalency range of the appended claims are intended to be embraced therein

What is claimed is:

1. An electronics device comprising:
a detector configured to detect motion external to the electronics device, the detector comprising:
a light sensor configured to detect light on a light-sensitive surface, and to generate a waveform based on a detected light pattern;
a mask having a predetermined pattern of light-transmissive and opaque areas to form the light pattern on the light-sensitive surface; and
a processor configured to detect the external motion based on the generated waveform.

2. The electronics device of claim 1 wherein the detector further comprises a lens to project the light through the mask and onto the light-sensitive surface.

3. The electronics device of claim 1 further comprising a light source to emit the light detected by the light-sensitive surface.

4. The electronics device of claim 1 wherein the predetermined pattern of light-transmissive and opaque areas comprises one or more openings formed in the mask that allow the light to pass through the mask to the light-sensitive surface.

5. The electronics device of claim 4 wherein the one or more openings are substantially vertically-oriented to distinguish horizontal motion, and/or substantially horizontally-oriented to distinguish vertical motion.

6. The electronics device of claim 1 wherein the processor is configured to:
process the generated waveform to detect one or more transitions between light and dark; and
determine a direction of movement based on a pattern of the detected transitions.

7. The electronics device of claim 6 wherein the processor is further configured to determine a size of an object in motion external to the electronics device based on the pattern of the detected one or more transitions.

8. The electronics device of claim 1 wherein the detector comprises first and second detectors separated by a distance, each including a respective mask having the predetermined pattern of light-transmissive and opaque areas to form respective first and second light patterns on the light-sensitive surface.

9. The electronics device of claim 8 wherein the light sensor comprises first and second light sensors configured to generate corresponding first and second waveforms based on the first and second light patterns, respectively.

10. The electronics device of claim 9 wherein the processor is configured to determine a distance between the electronics device and the object in motion based on a phase difference of the first and second waveforms.

11. The electronics device of claim 1 wherein the mask comprises first and second masks, each mask having a different predetermined pattern of light-transmissive and opaque areas to form respective first and second light pattern on the light-sensitive surface.

12. The electronics device of claim 11 wherein the controller is configured to multiplex the first and second light patterns to detect the external motion.

13. The electronics device of claim 11 wherein the masks are configured to be switched dynamically between the first mask and the second mask.

14. A method of detecting motion at an electronics device, the method comprising:
projecting light onto a mask in an electronics device;
masking the light through a predetermined pattern of light-transmissive and opaque areas to form a light pattern on a light-sensitive surface;
generating a waveform based on the light-pattern; and
processing the generated waveform at the electronics device to detect motion external to the electronics device.

15. The method of claim 14 wherein masking light through a predetermined pattern of light-transmissive and opaque areas comprises focusing the light to pass through a predetermined pattern of one or more openings formed in a mask.

16. The method of claim 14 wherein generating a waveform based on the light-pattern comprises generating a transition signal when the light-pattern indicates that an object external to the electronics device is moving.

17. The method of claim 16 further comprising generating the transition signal when the predetermined pattern of light-transmissive and opaque areas allow light reflected from the moving object to focus onto the light-sensitive surface.

18. The method of claim 16 further comprising generating the transition signal when the predetermined pattern of light-transmissive and opaque areas blocks light reflected from the moving object from focusing onto the light-sensitive surface.

19. The method of claim 14 wherein processing the generated waveform at the electronics device comprises:
processing the generated waveform to detect one or more transitions between light and dark;
identifying a pattern for the detected transitions; and
determining a direction of movement based on the identified pattern of transitions.

20. The method of claim 19 wherein processing the generated waveform at the electronics device further comprises determining a size of the object in motion based on the detected pattern.

21. The method of claim 14 further comprising:
masking the light through a pair of predetermined patterns of light-transmissive and opaque areas to form respective first and second light patterns on the light-sensitive surface;
generating corresponding waveforms based on the first and second light-patterns; and
processing the corresponding waveforms to determine a distance between the electronics device and an object in motion external to the electronics device.

22. The method of claim 21 wherein the processing the corresponding waveforms to determine the distance between the electronics device and the object in motion comprises calculating the distance based on a phase difference between the first and second waveforms.

23. The method of claim 14 wherein masking the light through a predetermined pattern of light-transmissive and opaque areas comprises masking the light through first and second masks, each mask having a different predetermined pattern of light-transmissive and opaque areas to form respective first and second light patterns on the light-sensitive surface.

24. The method of claim 23 further comprising multiplexing the first and second light patterns to detect the external motion.

25. The method of claim 23 further comprising dynamically switching between the first mask and the second mask.
